(19) United States
(12) Patent Application Publication
(10) Pub. No.: US 2002/0023860 A1
(43) Pub. Date: Feb. 28, 2002

(54) Method and system for garbage recycling

(76) Inventor: Bahram Rabiei, Montreal (CA)

Correspondence Address: Eric Fincham, 316 Knowlton Road, Lac Brome, QC, J0E 1V0, CA

(21) Appl. No.: 09/916,826

(22) Filed: Jul. 27, 2001

(30) Foreign Application Priority Data
Jul. 27, 2000 (IR) 26718

(51) Int. Cl. B03B 1/00; B02C 21/00

(52) U.S. Cl. 209/3; 209/11; 209/12.1; 209/930; 241/23; 241/24.1

(57) ABSTRACT

A garbage treatment plant and a recycling method for use by a community having a garbage pick up by garbage trucks, the method comprising the steps of collecting the food garbage and non food garbage in separate containers, transporting the food garbage and non food garbage to a garbage treatment plant wherein the food garbage is ground and heated to a temperature sufficient to kill pathogenic bacteria therein, and separating recyclable material from the non food garbage. The method is preferably practiced on a relatively small local scale and provides for a maximum of recyclable material and valuable by-products from the treated food garbage.

The present invention relates to recycling plants and a method for recycling.

The collection of waste material or garbage from residential dwellings is an almost universal practice. For many years, the garbage generated by people was placed in a suitable container (garbage can) where it was collected by garbage trucks and transported for disposal to a landfill site. The same basic process is still practiced with slight modifications. Today, plastic garbage bags have become wildly accepted and used instead of garbage cans. Also, the practice of recycling is used in many communities. This process involves separating recyclable materials such as plastics, glass, paper products from the regular garbage and are then disposed of in recycling operations. The non recyclable material is still dumped in a conventional manner.

One problem associated with the above practice is the disposal of the remaining non recyclable garbage at landfill sites. The amount of organic material contained therein is substantial and accordingly, attracts different types of vermin. As a result, the potential for the spread of disease is large. Also, pollution of the water table can occur.

It is an object of the presents invention to provide a method for the recycling of residential garbage which is environmentally sound and reduces environmental pollution.

It is a further object of the present invention to provide a garbage treatment plant useful in the practice of the method of the present invention.

According to one aspect of the present invention, there is provided a recycling method for use in a community having a garbage pick up by garbage trucks, the method comprising the steps of collecting food garbage and non food garbage in separate containers, transporting the food garbage and non food garbage to a garbage treatment plant, grinding the food garbage, heating the ground food garbage to a temperature sufficient to kill bacteria in the ground food garbage and separating recyclable material from the non food garbage.

According to a further aspect of the present invention, there is provided a garbage treatment plant suitable for use in a community having a garbage pick up by garbage trucks and wherein food garbage and non food garbage are collected separately, the garbage treatment plant comprising a receiving area, a food grinder, means to transport food garbage to the food grinder from the receiving area, a heating means arranged to heat the ground food garbage to a temperature of at least 200° C., and means to receive non food garbage and to separate recyclable materials therefrom.

The present invention provides several advantages. Under present practice, garbage is maintained, typically in garbage bags for a substantial period of time at a temperature which permits the growth and the spread of bacteria. The replacement of the garbage bags by garbage cans helps to overcome some of these problems. Typically, two different types of garbage cans with different colors or other identification can be used to identify food garbage and non food garbage.

Utilizing the present invention, cleaned garbage cans can be delivered at the same time as the used garbage cans are picked up for transport to the garbage treatment plant.

The method of the present invention is preferably initiated on a community wide basis and thus it would the responsibility of the community to provide the garbage cans and provide for the pick up and disposal of the material according to the method of the present invention. Preferably, the method is practiced on a local scale which avoids many of the problems when a large scale operation is attempted. Thus, preferably there would be a garbage treatment plant provided in a sufficient number of locals whereby any residence or household would not be further than 5 kilometers from the garbage treatment plant. This would enable the use of small trucks and provide for efficient operation of the recycling program.

Once the non food garbage cans and food containing garbage cans are transported to the facility, they are placed in different handling streams. This may be accomplished by any number of means, as will be discussed with respect to the preferred embodiment, by a conveyor.

The food garbage is culled by workers who ensure that any non food items are removed therefrom and placed in an appropriate receptacle or barrel. If the material removed therefrom is recyclable, it is then moved to the recyclable area.

The food garbage is then preferably treated to reduce it to a particulate and flowable state. This may be done by grinding or any other suitable mechanical means. At this point, the food garbage may have excessive water removed therefrom by a suitable dewatering process. This is preferably a suction type device although many dewatering arrangements are known in the art. The water removed may be treated in a suitable manner before discharge. Again, many water treatment methods are known in the art.

The dewatered food garbage is then heated to a temperature to destroy any pathogenic bacteria. Preferably, the food garbage is heated to a temperature of between 200° C. and 450° C. Following the heating and disinfecting, the food garbage may then be used as a fertilizer in, for example, composting.

The non food garbage is then further processed to remove all recyclable materials therefrom. This can conveniently be accomplished by culling the material while it moves along a conveyor belt. The remaining non food containing and non recyclable material containing garbage may then be disposed of in a landfill site.

The garbage cans may then be cleaned and disinfected and picked up by the same trucks which brought the filled garbage cans to the garbage treatment facility.

It will be understood that while Applicant has referred to a garbage can herein, any suitable container may be employed. Similarly, the possibility of using more than two types of garbage cans and various means of identifying the same is within the scope of the invention. The heating of the food garbage may be accomplished by any suitable means such as by use of natural gas which is a relatively environmentally friendly operation. During the treatment, the food garbage is kept completely covered to reduce any possibility of infection. The workers may utilize special sanitary clothes. Furthermore, in a preferred embodiment, there may be provided a portion of the facility for heating and melting plastic materials which then may be used to produce the garbage cans and pallets to carry the garbage cans. One could use recycled organic materials as fuel and produce compressed coal and charcoal. By using this method, it is possible to remove bacteria from plastic and wooden materials.

Having thus generally described the invention, reference will be made to the accompanying drawings illustrating an embodiment thereof, in which:

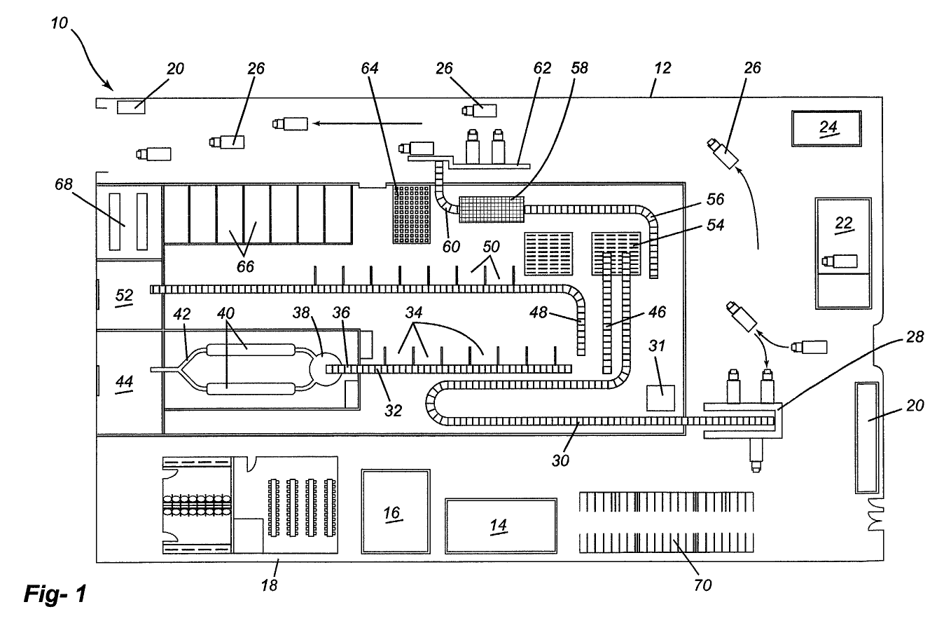

FIG. 1 is a schematic plan view of a garbage recycling plant according to one embodiment of the present invention; and

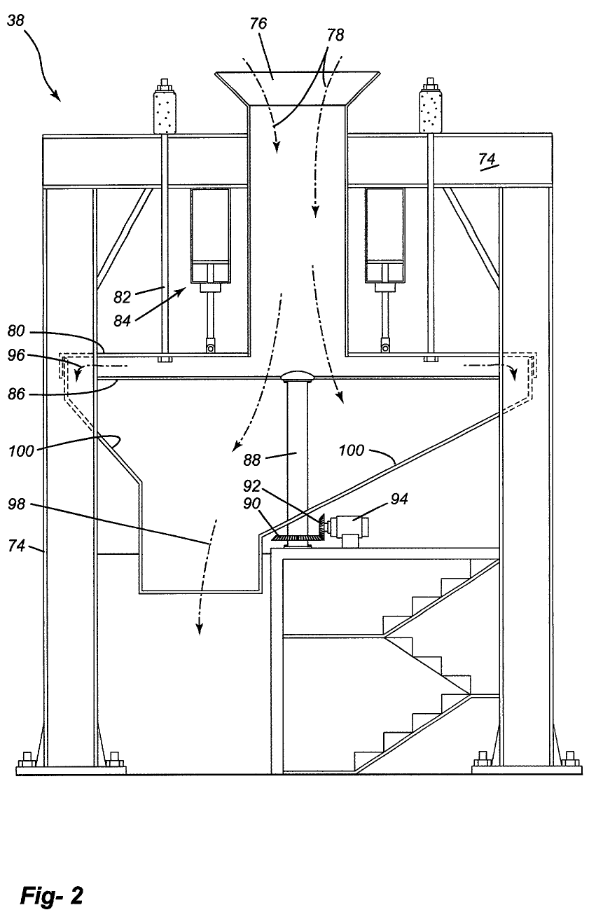

FIG. 2 is a side elevational view schematically illustrating a grinder used in the practice of the present invention.

Referring to the drawings in greater detail and by reference characters thereto, there is illustrated in FIG. 1, in schematic form, a garbage treatment plant according to an embodiment of the present invention and which garbage treatment plant is generally designated by reference numeral 10.

Garbage treatment plant 10 has a perimeter 12 extending thereabout. Perimeter 12 may form the exterior walls of an enclosed treatment plant or alternatively, may be in the form of a fence or other containment wall.

In the illustrated embodiment, there is provided an administration building generally designated by reference numeral 14, a health department building, generally designated by reference numeral 16 and a food service building 18 which can may contain food services and toilet facilities. Mounted at the entrance and the exit to the garbage treatment plant are guard offices 20.

The preferred embodiment of the invention also provides a vehicle service center 22 for the washing and repair of garbage trucks of which a plurality are shown going between different stations and which garbage trucks are generally designated by reference numeral 26. There is also provided a charcoal production facility housing a laboratory and a plastic melting facility all of which are generally designated by reference numeral 24.

Upon entry to the garbage treatment plant 10, the garbage trucks 26 would typically proceed to a unloading station 28. At loading station 28, the garbage cans containing both the non food garbage and the food garbage may be mounted on a first conveyor 30. Extending parallel with a portion of first conveyor 30 is a food conveyor 32 onto which the garbage cans containing food garbage are dumped. The food garbage is then culled for any non food item which may be placed in barrels 34.

The food remaining on food conveyor 32 will then proceed to an elevator 36 to transport the food garbage to a food grinder 38.

Referring to FIG. 2, food grinder 38 has a plurality of structural members 74 and includes an upper funnel generally designated by reference numerals 76. The food garbage from elevator 36 enters upper funnels 76 as indicated by arrows 78.

Grinder 38 includes an upper grinding plate 80 suitably mounted on supports 82. The positioning of upper grinding plate 80 may be adjusted by means of hydraulic cylinders 84.

A lower grinding plate 86 is mounted on a shaft 88 having a beveled gear 90 situated at a lower end thereof.

Bevel gear 90 on shaft 88 mates with a second bevel gear 92 which is driven by a suitable motor 94.

Food entering through upper funnel 76 enters between upper grinding plate 80 and lower grinding plate 86 from whence it will move outwardly as indicated by arrows 96. The ground food garbage will then enter a lower funnel 100 and be fed by gravity as indicated by arrows 98.

Referring back to FIG. 1, the ground food garbage from lower food funnel 100 then continues on a conveyor through a heating furnace 40. In the illustrated embodiment, there are illustrated two conveyors passing through heating furnace 40 from where the ground dried garbage is fed by conveyor 42 to a fertilizer depot 44.

During the transport through the heating furnace, the food garbage is preferably heated at a temperature of between 200 to 350° C.

The garbage cans containing non food garbage are then transferred to a conveyor 46 and the non food garbage is then dumped from the containers onto a further non food garbage conveyor 48. As the non food garbage travels along conveyor 48, it is manually separated and recyclable materials are placed in barrels 50. The non recyclable material and non food garbage then goes to a warehouse 52 for ultimate disposal to a land fill.

The empty garbage cans from conveyor 46 and 30 then pass to a washing station 54 where they are cleaned. The cleaned garbage cans are then placed on a clean garbage conveyor 56 from where they pass through a microwave station 58. Subsequently, they are passed by conveyor 60 to a loading dock 62 where they may be loaded onto the garbage trucks for distribution to the various households. Conveniently, a garbage can storage depot 64 may be located proximate thereto.

Garbage treatment plant 10 may also include a warehouse 66 for containing the recyclable material before their ultimate disposal. Similarly, there may be provided an appliance warehouse 68 designed to receive and recycle domestic appliances such as washers, dryers, stoves, fridges, etc. A vehicular garage 70 may also be provided.

As will be seen from the above, a compact garbage treatment plant is provided from where the garbage trucks 26 may unload their garbage, proceed immediately to pick up clean containers and continue on their route.

Preferably, the operation is sized such that a plurality of such garbage treatment plants may be provided, each serving a relatively small locale. Thus, preferably there would be a garbage treatment plant within five kilometers of any household. The trucks used would be smaller compared to those conventionally used and would be designed to provide clean garbage cans to each household at the same time as picking up the old garbage.

Although far more labor intensive than today's plants, the achievement of total recycling and production of valuable by-products such as the fertilizer would help to offset the costs of operation. In addition, the benefits of elimination of a lot of disease would be achieved.

It will be understood that the above described embodiments are for purposes of illustration only and that changes and modifications may be made thereto without departing from the spirit and scope of the invention.

I claim:

1. A recycling method for use by a community having a garbage pick up by garbage trucks, the method comprising the steps of:
(a) collecting food garbage and non food garbage in separate containers;
(b) transporting said food garbage and said non food garbage to a garbage treatment plant;
(c) grinding said food garbage;
(d) heating said ground food garbage from step (c) to a temperature sufficient to kill bacteria in said ground food garbage; and
(e) separating recyclable material from said non food garbage.

2. The method of claim 1 wherein said step of heating said ground food garbage comprises the step of heating said ground food garbage to a temperature of at least 200° C.

3. The method of claim 2 further including the step of dewatering said ground food garbage from step (c) prior to heating said ground food garbage.

4. The method of claim 3 wherein the step of dewatering said ground food garbage comprises using a suction filter device.

5. The method of claim 1 wherein the step of separating recyclable material from said non food garbage comprises separating said recyclable material into plastic material, glass, paper products and metal.

6. The method of claim 1 further including the step of subjecting said non food garbage to a disinfection operation.

7. The method of claim 1 wherein said non food garbage remaining from step (e) is disposed of in a landfill operation.

8. A garbage treatment plant suitable for use by a community having a garbage pick up by garbage trucks, and wherein garbage and non food garbage are collected separately, the garbage treatment plant comprising a receiving area, a food grinder, means to transport food garbage to said food grinder from said receiving area, a heating means arranged to heat ground food garbage to a temperature of at least 200° C., and means to receive non food garbage and to separate recyclable materials therefrom.
